(19) United States
(12) Patent Application Publication
(10) Pub. No.: US 2006/0062366 A1
(43) Pub. Date: Mar. 23, 2006

(54) Overlapped voice conversation system and method

(75) Inventors: Saravanakumar V. Tiruthani, Santa Clara, CA (US); Marcelo G. Oliveira, San Jose, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and communication Networks, Inc.

(21) Appl. No.: 10/948,705

(22) Filed: Sep. 22, 2004

(51) Int. Cl. H04M 3/42

(52) U.S. Cl. 379/201.01; 379/215.01

(57) ABSTRACT

Two or more calls to the same destination are mixed. The mixed audio information includes foreground and background calls. The call in the foreground is mixed with a higher volume level than background calls. A key, button, switches or other information is used to switch between foreground and background calls. By reducing the volume of a background call but still providing audio information from the background call, a user may hold a conversation for the foreground call while monitoring information being provided in the background call. Conversation is provided for the foreground call, but only one way communications to the destination are provided for the background. Alternatively, two way communications are provided on background calls.

### BACKGROUND

The present invention relates to handling multiple calls to a same destination. In particular, the connection of more than one audio call to a same destination at a same time is performed in a communication system.

Effective communication is critical for successful business. The desire to enhance communication, in conjunction with advances in processing technology, has led to new and effective communication systems for businesses and individuals. For example, traditional data-only networks have now merged with traditional voice-only networks to form hybrid internet protocol telephone systems. Traditional voice-only networks have also increased sophistication, providing various options to users. The cost and performance benefits provided by both IP and voice-only telephone systems has led to successful implementation of various telephone call options, including the use of hold and conference calling.

In conventional telephone systems, a user participates in a single active call on a single device at any point and time. If there is more than one call, one of the calls may be active and the other call is placed in a held state or on hold. The caller placed on hold typically hears music or silence. A user receiving two calls may switch between the two calls, switching one call from being on hold to active and the active call to being on hold. By placing a call on hold, a person receiving the held call may miss important information.

A user may also switch the two calls together to create a conference call. Each of the parties may participate in the conversation at a same time.

### SUMMARY

The present invention is defined by the following claims, and nothing in this section should be taken as a limitation on those claims. Systems and methods are provided for handling multiple calls at a same destination. Two or more calls to the same destination are mixed. The mixed audio information includes foreground and background calls. The call in the foreground is mixed with a higher volume level than background calls. A key, button, switches or other information is used to switch between foreground and background call. By reducing the volume of background calls but still providing audio information from the background call, a user may hold a conversation for the foreground call while monitoring information being provided in the background call. In one embodiment, conversation is provided for the foreground call, but only one way communications to the destination are provided for the background. Alternatively, two way communications are provided on background calls.

In a first aspect, a system is provided for handling multiple calls to a same destination. A first phone device has a speaker and a microphone. An audio mixer is operable to connect at least two different calls substantially, simultaneously with the speaker while the microphone is connected with the first call and is free of connection with the second call.

In a second aspect, a method is provided for handling multiple calls to a same destination. A first call is connected between two locations with two way communications. A second call is connected between one of the locations and a third location with a one-way communication for at least a portion of the second call. The connections are performed substantially simultaneously.

In a third aspect, a method is provided for handling multiple calls to a same destination. Audio information is communicated over a phone system from a first audio source to a person. Audio information from over the phone system from a different audio source is mixed with the audio information from the first audio source. The audio information from the first audio source is mixed as foreground audio and the audio information from the second audio source is mixed as background audio.

In a fourth aspect, a system is provided for handling multiple calls to a same destination. An audio mixer is operable to mix audio from two different audio sources. The information from one source is mixed as foreground audio and the information from the other source is mixed as background audio. A first phone device is operable to receive the mixed audio output.

Further aspects and advantages of the invention are discussed below in conjunction with the preferred embodiments. Any one or more of the aspects or advantages described above or below may be used independently or in combination and may be later claimed.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for handling multiple calls to a same destination;

FIG. 2 is a flow chart diagram of one embodiment of a method for handling multiple calls to a same destination; and

FIG. 3 is a flow chart diagram of another embodiment of a method for handling multiple calls to a same destination.

### DETAILED DESCRIPTION

The elements illustrated in the Figures interoperate as explained in more detail below. Before setting forth the detailed explanation, however, it is noted that all of the discussion below, regardless of the particular implementation being described, is exemplary in nature, rather than limiting. For example, although selected aspects, features, algorithms or components of the implementations are depicted as being stored in memories, all or part of systems and methods consistent with the handling of multiple calls to a same destination may be stored on or read from other machine-readable media, for example, secondary storage devices such as hard disks, floppy disks, and CD-ROMs; a signal received from a network; or other forms of ROM or RAM either currently known or later developed.

Furthermore, although specific components of the phone system will be described, methods, systems, and articles of manufacture consistent with the phone systems may include additional or different components. For example, a processor may be implemented as a microprocessor, microcontroller, application specific integrated circuit (ASIC), discrete logic, or a combination of other types of circuits acting as explained above. Similarly, memories may be DRAM, SRAM, Flash or any other type of memory. With regard to databases, tables, and other data structures, they may be separately stored and managed, incorporated into a single memory or database, or logically and physically organized in many different ways. One or more programs may be parts of a single program, may be separate programs, or may be distributed across several memories or processors. Any now known or later developed telephony or audio communications system may be used.

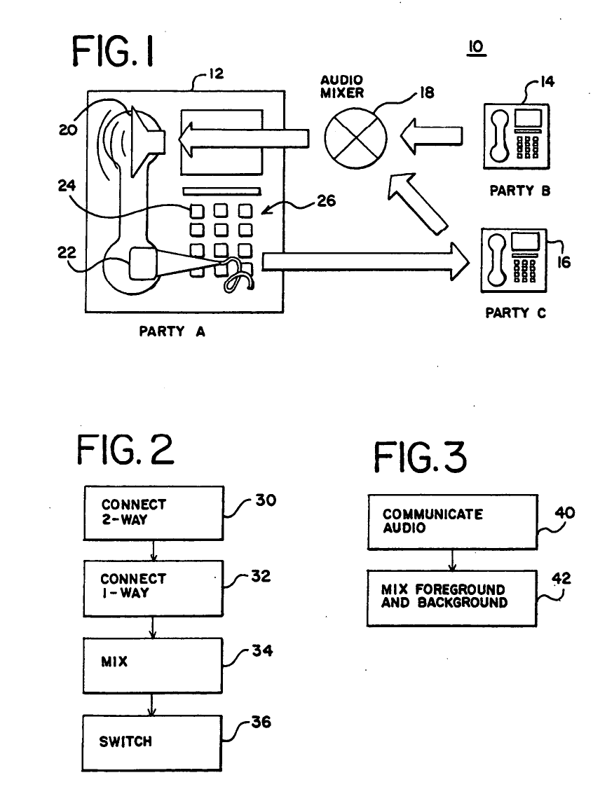

FIG. 1 shows one embodiment of a system 10 for handling multiple calls to a same destination. The system 10 is a conferencing system, PBX, POTS, PSTN, digital communications system, analog communications system, or other now known or later developed telephony system. For example, the system 10 is a network of components connected together using one or more different network popologies and technologies. An ethernet, fiber distributed data interconnect, copper distributed data interfaced, or other network technology may be used. For an Internet protocol packet switch network as the system 10, addressed packet communications are used. For example, the system 10 reports transmission and reception of user datagram protocol (UDP) packets for communications between the various components. The components each connect through dial-up, DSL, T1, ethernet, or other now known or later developed network connections. In one embodiment, the system 10 uses pactized communications with a high speed protocol. For example, a real time protocol over UDP provides responsive voice conferencing and other communications between end points or audio sources. The signaling throughout the system may use the H.323 packet based multimedia communications system standard published by International Telecommunications Union. In other implementations, the system 10 employs an additional or alternative protocol, such as session initiation protocol for internet conferencing, telephoning, presence, event notification and instant messaging. MEGACO (H.248) or MGCP, both standing for Media Gateway Control Protocol, could be used in other embodiments. Other protocols include jabber or SIP for instant messaging and presence leveraging extensions (SIMPLE).

Audio information, such as voice information from a call is sent to or received by various endpoints within the system 10 as pacatized voice data. For example, packets that contain approximately 30 milliseconds of voice data are transmitted from one end point to a server, buffer or other end point for routing or generation of audio information. Greater or lesser time periods may be used for any given packet. Each end point and other components within the system 10 are assigned a network address to identify the component or end point. The network address may include an IP address, or an IP address and port number. Alternative addressing techniques may be used to identify and direct audio information between components.

The system 10 is a stand alone processing system or is integrated with other processing systems that perform other functions. Alternatively, the system 10 is distributed between multiple logically or physically separate processing systems. Other packet types, protocols or structures may be employed. Telephone systems using public switched network for communicating multiplexed analog or digital audio information are used in alternative embodiments. Cellular, mobile or satellite telephone systems may alternatively or additionally be used.

The system 10 includes a phone device 12 and mixer 18. Additional, different or fewer components maybe provided, such as including additional phone devices 14 and 16 within the system 10. As another example, one or both of the additional phone devices 14, 16 are provided in different systems 10 but are directly or indirectly connected with the system 10. The phone device 12 acts as an end point within the network, but maybe associated with a server or other component acting as an intermediate communications point.

The phone device 12 includes a speaker 20, a microphone 22 and an optional key or button 24. The phone device 12 is implemented using any of various structures, such as a personal computer, a telephone set or other device for receiving and transmitting audio information. For example, the phone device 12 is a personal computer with a microphone 22 for digitalizing voice data. The digitalized voice data is encoded and transmitted through the network 10. The phone device 12 decodes received voice data and reproduces the voice or audio information using a sound card and a speaker 20. The phone device 12 has a network address for identifying the phone device from other devices or components, such as a phone number, IP address or an IP address and port number. Any of class A, B, C, D or E IP addresses may be used. Alternatively, the address adheres to other standards, such as an IP v6 standard. These standards provide for multiple or single connections. The phone device 12 is shown as a telephone and may be implemented as a telephone or other device. Any now known or later developed phone device 12 may be used, such as a mobile telephone, a satellite phone, a personal computer, or a portable computer. The speaker 20 and microphone 22 correspond to the structure of the phone device 12, such as a speaker 20 being a floor standing, desk standing, free standing, ear bud, or other miniature or large speaker. The microphone 22 is any now known or later developed microphone for receiving audio information.

The phone device 12 includes one or more controllers for running algorithms to encode, decode and control the phone device. In one embodiment, the algorithms are implemented within the phone device 12, but maybe implemented in part or in total in devices external to the phone device 12.

The other phone devices 14, 16 are the same as the phone device 12, but may have different structures. For example, home or office phone devices 12 may be different for different people, such as a telephone set for the phone device 14 and a personal computer for the phone device 16. The phone devices 12, 14, 16, separate devices or some of the phone devices are operable to receive packet switched communications. For example, a remote server converts packet switched communications into analog audio information for providing to a telephone set. As another example, packet switch communications are provided to a telephone set 12 and converted by the telephone device 12 into audio information on the speaker 20.

The audio mixer 18 is an analog or digital mixer. In one embodiment, the audio mixer 18 is a digital summer, such as implemented on a processor, application specific integrated circuit, logic circuit, digital circuit, field program gate array, filter or other now known or later developed combining device. For example, the audio mixer 18 is implemented by a processor on the phone device 12 or remote from the phone device 12, such as a conferencing or telephone bridge or server, other server, or other processor. The controller of the phone device 12 or separate processor implements the audio mixer 18 for mixing local to the phone device 12, such as within a same housing or room as the phone device 12.

The audio mixer 18 sums digital data for mixing. Weighted summation may be provided in other embodiments. For analog mixing, an analog sum is performed. The audio mixer 18 includes amplifiers and/or attenuators. For example, digital data is multiplied by a weight to either amplify or attenuate information.

The audio mixer 18 is operable to connect with different calls, such as from the other phone devices 14 and 16 substantially simultaneously. Substantially simultaneously accounts for time division multiplexing using different time slots for the two different phone devices at 14, 16 and associated calls. If audio is played from both calls, the user perceives the audio as being received simultaneously. Substantially is also used herein to account for delays associated with processing, such as differences in encoding, decoding or transmission and reception process times of one call relative to another call. Interleaving the processing of calls with tens of milliseconds of difference may provide for calls existing at a substantially same time, such as perceived by the user.

The audio mixer 18 outputs information to the phone device 12 and the associated speaker 20. The audio mixer 18 is connected with the speaker 20 directly or indirectly. The connection may be multiplexed or constant. Similarly, the microphone 22 is connected through the phone device 12 to one or both of the other phone devices 14, 16 through the audio mixer 18 or along a different communications route.

As shown in FIG. 1, the connection between the phone device 12 and one of the other phone devices 16 is a two way connection where audio information from the other phone device 16 is routed through the audio mixer 18. The connection between the phone device 12 and the other of the phone devices 14 is a one way communication where audio information is routed though the audio mixer 18 to the phone device 12. The communications between the phone device 12 and the other phone device 14 are free of two way communications. For example, the output of the microphone 22 is free of a connection with an audio output of the other phone device 14 or connection with the call between the phone device 12 and the other phone device 14. In alternative embodiments, a two way communication is used between the phone device 12 and the other of the phone devices 14. The connections shown as large arrows in FIG. 1 may be direct or indirect connections, such as being routed through one or more other servers or components.

The audio mixer 18 outputs audio information for the phone device 12 associated with two different calls. One of the calls is output as foreground audio and the other call is output as background audio. For example, audio data received from a data source, such as the other phone device 14, is output as background information, and audio information from a different audio source, such as the other phone device 16, is output as foreground audio data. Foreground and background data is distinguished by volume. For example, the audio mixer 18 attenuates the audio information from one audio source, such as the other phone device 14. Alternatively or additionally, the audio information for the foreground audio is amplified. The relative amount of attenuation, amplification or both attenuation and amplification is set at any of various levels desired by the user or pre-designed levels. For example, the background audio is sufficiently lower in volume to allow focusing or concentration on foreground audio as desired, yet still allowing discrimination or understanding of the background audio if desired. The differences in volume allow the user to distinguish or differentiate between the foreground and background calls and associated audio.

The button 24 is associated with a switch 26. The switch 26 is an analog or digital switch. For example, the switch 26 is implemented as part of a controller for switching between different phone functions or switching call operations. The switch 26 is positioned with the audio mixer 18 in one embodiment, but may be positioned in a different location than the audio mixer 18 in other embodiments. In one embodiment, the user depresses the button 24 in order to switch the call associated with background information to the foreground and a call associated with foreground information to the background. Alternatively or additionally, the same switch 26 or different switches are used to disconnect either the foreground or background call.

The button 24 is a key to control operation of the switch 26. In an alternative embodiment, a voice recognition process is used to control the switch 26. For example, a user speaks a term or series of words unlikely to occur in everyday conversation in order to trigger switching by the switch 26 between the foreground and background calls. In response to a switch between calls, the audio mixer 18 is caused to attenuate the different call or switch the foreground and background audio.

The switch 26 is additionally or alternatively used to initiate configuration of the foreground and background calls. Using triggered messaging in response to user input where the audio mixer 18 is remote or using control within the phone device 12 where the audio mixer 18 is local, the foreground and background mixing process is initiated in response to user input. Where the mixer 18 is remotely positioned, the mixer 18 is associated with a network address. The network is programmed to provide for routing different calls to the mixer 18 for output to the phone device 12.

As described above, each of the calls is associated with two end points. In alternative embodiments, one or more of the calls are associated with three or more end points, such as a conference call. While two calls are shown, three or more calls may be connected together and mixed together by the audio mixer 18. Any number of calls may be mixed as background calls, and any number of calls may be mixed as foreground calls. Different calls may be associated with different durations. Mixing as foreground and background audio is provided for overlapping.portions of the durations of the calls. The mixing as foreground and background may be provided for only a portion of the overlapping length of the calls, such as associated with starting out with or ending with a conference call and beginning or ending with foreground and background audio mixing or without two way communications along only one of the calls.

FIG. 2 shows one embodiment of a method for handling multiple calls to a same destination. The method is implemented using the system 10 described above for FIG. 1 or a different system. Additionally, different or fewer acts may be provided then shown in FIG. 2. For example, act 32 may correspond to connecting two way communications rather than just one way communications. As another example, the method shown in FIG. 2 is performed without the switching of act 36.

In act 30, a first call is connected between two different locations. Audio information is communicated over a phone system from an audio source to a different location, such as to a person. The connected call is a two way communications, such as allowing conversation between the audio source and the person or allowing the transmission of audio information along the same or different communications path between the two end points.

In act 32, a second call with a common end point as the first call is connected. The second call is associated with one way communications for at least a portion of the second call. For example, audio information is provided from a third location to the primary location or destination of both calls. The call is free of audio information being transmitted from the common destination or primary location to the other end point. Being free of audio information is as perceived by the user, such as free of transmission of audio information for at least a second. Any audio information received by microphone is muted or not routed to the other end point of the call. Alternatively, a two way connection is established allowing communications along both directions of both or all calls, such as associated with a conference call.

The two calls established by the connections in acts 30 and 32 may be over a permanent or set communications path. Alternatively, continuously varying paths associated with packetized routing algorithms are provided. Regardless of the routing or path, the call is connected such that the user may hold a conversation or listen to audio information with minimal interruption due to transmission of audio information.

The two or more calls connected in acts 30 or 32 occur substantially simultaneously. One of the calls overlaps in time period with another of the calls from a user perspective. Using packet communications or analog signals over a plain old telephone network, a portion of one of the calls overlaps with a portion or the entirety of another of the calls. The calls may be of the same duration or different duration or same or different starting and ending times.

In act 34, audio information from two different calls or associated two different locations is mixed. The audio information provided over a phone system is mixed to provide foreground audio and background audio. For example, audio information from one location is mixed as background with audio information from a different location being mixed as foreground. The audio information of one location is mixed at a lower volume than audio information from another location. For example, one of relative attenuation, relative amplification or both relative attenuation and amplification of the different audio information is performed.

The mixing of act 34 is performed at a remote location than the destination of the two different calls. Alternatively, the mixing is performed at the location or destination of the calls. The mixing as foreground and background information is performed during an overlapping time period of the two calls. The mixing may be provided for the entire overlapping time period or for only a portion of the overlapping time period. Separate or the same mixing may be provided for additional calls, such as mixing together three or more calls.

The foreground and background mixing is initiated by the user, such as a user at the destination of the two or more calls. After a first call is connected, the user connects a second call caused by the user or received by the user by depressing a button associated with foreground and background. Controls for switching a current call to the background and receiving a new call the foreground may be provided. Controls for automatically putting the newly received call as the foreground call and a previously received call as the background call are alternatively or additionally provided.

Referring to FIG. 1, the mixing performed in act 34 of FIG. 2 allows party A to hear audio from party C in the foreground and audio from party B in the background. By attenuating the volume of the audio information received from party B and mixing the two different audio streams, both foreground and background audio is provided to party A. The difference in volume levels or attenuation of the different sources of audio information allows party A to differentiate between foreground and background audio. Communications from party A are provided only to party C, but may be provided to both parties C and party B in alternative embodiments.

In optional act 36, the foreground and background or one way and two way communications for the two calls are switched. In response to user input, such as depressing a key or button or speaking a voice command, the calls are switched. The mixer is caused to attenuate and mix a different one of the calls as background and the other of the calls as foreground. The switch may additionally include converting from one way to two way communications. Alternatively, both calls are maintained as two way communications or the same combination of one way and two way communications is provided regardless of which call is used as the background and foreground.

FIG. 3 shows another embodiment of a method for handling multiple calls at a same destination. The method of FIG. 3 is performed using the system 10 described for FIG. 1 or a different system.

In act 40, audio information is communicated to a destination. Communicated audio information is associated with two or more calls connected with the destination. None, one, a subset or all of the calls are associated with two way communications. One way communications may be provided in alternative embodiments. Two way communications is relative to the destination. For example, two way communications allows a conversation with two or more parties in a conference call.

In act 42, the audio information from the two different calls is communicated as foreground and background information. The audio information from the two calls is mixed together at different volume levels. By allowing the user to maintain a background call while participating in a foreground call, the user may participate in a one call without losing track of what is happening in the background call.

In one example use, a user is able to receive and participate in an audio call while listening to an active audio conference in the background. Referring to FIG. 1, party B represents an ongoing conference call. Party C is a person with whom party A is having an active conversation. Party C will hear party A but will not hear the conference. Similarly, the participants in the conference do not hear the conversation between parties A and C. For example, party A wants to confirm information to be provided to the conference participants during the conference. Party A is able to monitor the conference while obtaining the information through audio communications.

As another example use, the user is able to receive and/or participate in an audio call while waiting for a call agent. With reference to FIG. 1, party B represents a company or other source that has placed party A on hold, such as delivering music while waiting for an available agent. Party A may have an active conversation with party B while hearing the music in the background from party C. Once the agent becomes available, party A hears the difference, such as from the music to the voice of a person. Party A can then switch the conversation with party B to the foreground while hanging up on or moving party C to the background.

Yet another example use is obtaining a recently received urgent or other voicemail without disconnecting from an ongoing call or conference. Referring to FIG. 1, party C represents a voicemail application. Party B is one or more callers participating in an ongoing call, such as a conference call. Party A is able to obtain voicemail access and information using foreground communications while continuing to monitor the other call. Alternatively, party A is able to continually participate in the call with other parties on a foreground level while accessing voicemail on a background level.

A similar use is for accessing voice enabled applications while in a call. For example, a user might decide to start recording a call or implement some other voice enable application during an active call. To evoke or interact with the voice enabled application, a second call is made as the background or foreground call while maintaining the ongoing or active other call. Party A as shown in FIG. 1 may interact with the voice enabled application (party C) using one call while hearing or monitoring audio from party B in the background or foreground. Another specific example allows party A to access the conference control system (party C) for an ongoing conference call with party B. The conference control system is accessed to allow audio based alteration of the conference call, such as allowing addition of another participant or placing a call to add another participant.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and the scope of this invention.

What is claimed is:

1. A system for handling multiple calls to a same destination, the method comprising:
a first phone device having a speaker and a microphone; and
an audio mixer operable to connect at least first and second different calls substantially simultaneously with the speaker while the microphone is connected with the first call and free of connection with the second call.

2. The system of claim 1 wherein the first phone device comprises a personal computer.

3. The system of claim 1 wherein the first phone device comprises a telephone.

4. The system of claim 1 wherein the audio mixer comprises a digital summer.

5. The system of claim 1 wherein the audio mixer is operable to output audio information from the first call at a higher volume than the second call.

6. The system of claim 5 wherein the audio mixer is operable to attenuate audio information from the second call.

7. The system of claim 1 further comprising a switch operable to switch the connection to the microphone from the first call to the second call while the speaker is connected with the first and second calls.

8. The system of claim 7 wherein the first phone device comprises a key, the switch operable to switch in response to the key.

9. The system of claim 1 further comprising:
second and third phone devices connected with the audio mixer, the first call between the first and second phone devices and the second call between the first and third phone devices.

10. The system of claim 1 wherein the audio mixer is remote from the first phone device.

11. The system of claim 1 wherein the audio mixer is local to the first phone device.

12. The system of claim 1 wherein at least the first call comprises packet switched communications.

13. A method for handling multiple calls to a same destination, the method comprising:
(a) connecting a first call between a first location and a second location with two way communications; and
(b) connecting a second call between the first location and a third location with one way communications for at least a portion of the second call;
wherein (a) and (b) are performed substantially simultaneously.

14. The method of claim 13 wherein the first and second calls connect with the first location at an overlapping time from a user perspective, the portion of the second call being at least in part during the overlapping time.

15. The method of claim 13 wherein (b) comprises connecting the second call with audio information from the third location provided to the first location, the portion of the second call free of audio information from the first location provided to the third location.

16. The method of claim 15 further comprising:
(c) mixing audio information from the second and third locations for the first location, the audio information from the third location being at a lower volume than the audio information from the second location.

17. The method of claim 16 wherein (c) comprises attenuating the audio information from the third location.

18. The method of claim 13 further comprising:
(c) switching from two-way to one-way communications for the first call and from one-way to two-way communications for the second call.

19. The method of claim 18 further comprising:
(d) receiving user input, the switching of (c) responsive to the user input.

20. The method of claim 16 wherein (c) is performed remote from the first location.

21. The method of claim 16 wherein (c) is performed at the first location.

22. The method of claim 13 wherein at least one of (a) and (b) comprises transmitting packet switched communications.

23. The method of claim 13 wherein at least one of (a) and (b) comprises transmitting analog signals over a plain old telephone network.

24. A method for handling multiple calls to a same destination, the method comprising:
(a) communicating audio information over a phone system from a first audio source to a person; and
(b) mixing audio information over the phone system from a second audio source different than the first audio source with the audio information from the first audio source, the audio information from the first audio source mixed as foreground audio and the audio information from the second audio source mixed as background audio.

25. The method of claim 24 wherein (b) comprises attenuating the audio information from the second audio source.

26. The method of claim 24 further comprising:
(c) communicating audio information from the person to the first audio source while performing (a) and (b);
wherein audio information from the person is not communicated to the second audio source during at least a second of the communications of (c).

27. The method of claim 26 further comprising:
(d) switching from communicating the audio information from the person to the first audio source while performing (a) and (b) to communicating the audio information from the person to the second audio source while performing (a) and (b).

28. The method of claim 24 wherein (a) and (b) are performed in a conference call between the person, the first source and the second source.

29. A system for handling multiple calls to a same destination, the system comprising:
an audio mixer operable to mix audio from a first audio source with the audio information from a second, different audio source, the audio information from the first audio source mixed as foreground audio and the audio information from the second audio source mixed as background audio; and
a first phone device operable to receive an output of the audio mixer.
